(19) United States
(12) Patent Application Publication
(10) Pub. No.: US 2008/0091616 A1
(43) Pub. Date: Apr. 17, 2008

(54) Communication System And Method Using Visual Interfaces For Mobile Transactions

(76) Inventors: Erich Helwin, Kehrsatz (CH); Thomas Kolly, Bern (CH)

Correspondence Address: UNISYS CORPORATION, UNISYS WAY, MAIL STATION: E8-114, BLUE BELL, PA, 19424, US

(21) Appl. No.: 11/793,279

(22) PCT Filed: Jul. 4, 2005
(86) PCT No.: PCT/EP05/07199

§ 371 Date: Jun. 15, 2007

Related U.S. Application Data
(60) Provisional application No. 60/636,248, filed on Dec. 15, 2004.

(51) Int. Cl. G06Q 20/00

(52) U.S. Cl. 705/72; 705/73; 705/75; 705/76

(57) ABSTRACT

The invention relates to a system and a method for providing a mobile transaction, such as a payment, the system including: a first means at a point of sale for entering transaction data and customer data and having a unique ID associated therewith; and a mobile transaction platform connected via a first link to the first means, the mobile transaction platform being adapted to receive the transaction data, the customer data and the unique ID, and to route the transaction data, the customer data and the unique ID to a payment provider for obtaining authorization for an electronic fund transfer at the point of sale, the mobile transaction platform being further adapted to provide the authorization information of the payment provider via a second link, which is distinct from the first link, to a mobile device of the customer, wherein the authorization information is in form of a machine readable visual symbol, the first means being adapted to read and decode the visual symbol from the mobile device and to send the decoded visual symbol via the first link to the mobile transaction platform for finalizing the transaction.

### BACKGROUND OF THE INVENTION

The present invention relates to the field of mobile transactions and more specifically to a system and a method of providing a simple and secure way for facilitating mobile transactions such as payment, ticketing and access.

Several telecommunications providers and similar competitors in the computer marketplace offer “mobile payment” solutions. In 2001 with the eCommerce boom—many start-up companies and telecommunications providers attempted to provide fancy mobile payment solutions. These solutions were often ephemeral. That is, they appeared and then disappeared from the marketplace, many times within the same year, and only to be replaced.

Current solutions that are still in existence rely on the mobile phone as the device to execute transactions. The problem with these solutions is that they are still error-prone and cumbersome. In addition, all of the deployed solutions impose limitations in process sequence, usability and security. A summary of the limitations imposed by all of the current solution offerings thus include the following:
1). The process sequence and usability in all solutions on the marketplace are too complex and tricky. The solutions require multiple communication steps and user interactions between the involved parties. This makes the hand;
2). In cases where an initiated transaction can't be terminated for any reason, there is currently no simple rollback process available; and,
3). As unique transactions are performed and executed—security is a major important issue and must be considered. The solutions must be secure as to prevent Trojan programs and the like from gaining access to the mobile device and/or the transaction data. Current implementations in the marketplace do not employ or recommend any security methods for preventing such attacks, which may be acceptable considering the above limitations, but is not acceptable in terms of a fully secure mobile transaction system.

### SUMMARY OF THE INVENTION

In view of the above it is an object of the present invention to provide a system and method which enables mobile devices (mobile phones, smart phones, PDA's and the like) to perform transactions in an easy, simple and secure way.

Another object of the present invention is to provide for a system and a method to perform transactions in an easy and secure way by avoiding the use of credit cards or electronic cash cards (EC cards) while preserving at the same time the simplicity of such known card payment systems. In particular, the system and method according to the invention is aimed towards providing an alternative to payments via electronic cash without impairing safety, simplicity (for the end user) and wide acceptance of electronic cash systems.

The above and further objects to become apparent hereinafter are achieved

### BRIEF DESCRIPTION OF THE DRAWINGS

Further characteristics and advantages of the invention will become better apparent from the following description of a preferred but not exclusive embodiment of the implant system according to the invention, illustrated by way of non-limitative example in the accompanying drawings wherein:

FIG. 1 shows a first embodiment of the equipment for use in carrying out mobile payments at a retail store or the like,

FIG. 2 shows a second embodiment of the equipment for use in carrying out mobile payments at a retail store or the like, and

FIG. 3 shows an enhancement of the second embodiment of the equipment for use in carrying out mobile payments at a retail store or the like with an extension IMTP coupon module.

### DETAILED DESCRIPTION OF THE PREFERRED EMBODIMENTS

In general terms the solution of the present invention accomplishes the above stated objects by means of a visual interface (visual symbol) on the mobile device, of optical technology, and of an Innovative Mobile Transaction Platform (IMTP)—also mobile transaction platform—solution architecture which preferably maps a received registration number of the user of the mobile device (or the mobile device number) into a card number. The card number can be used by a payment provider in the same manner as in a conventional system with an electronic fund transfer at a point of sale (EFT/POS) transaction. Alternatively, the mapping or conversion of the registration number into a card number may take place at the end of the payment provider.

At the outset, some terms should be defined.

The term “mobile transactions” or “transaction” may include:
Mobile payment transactions (payment, voucher, coupon, or the like)
Ticketing transactions
Access (physically and electronically)

The term “visual interface” or “visual symbol” may be understood to include:
1D, 2D barcode etc.
Hologram
OCR
Or all machine readable visual symbols and formats

Finally, the term “communication” is meant to include:
SMS (Nokia Picture SMS, EMS, and the like) combined with visual symbols like a 2D barcode (see generic term “visual interfaces”)
MMS combined with visual symbols like a 2D barcode (see generic term “visual interfaces”)
Email with attached visual symbols like a 2D barcode (see generic term “visual interfaces”)

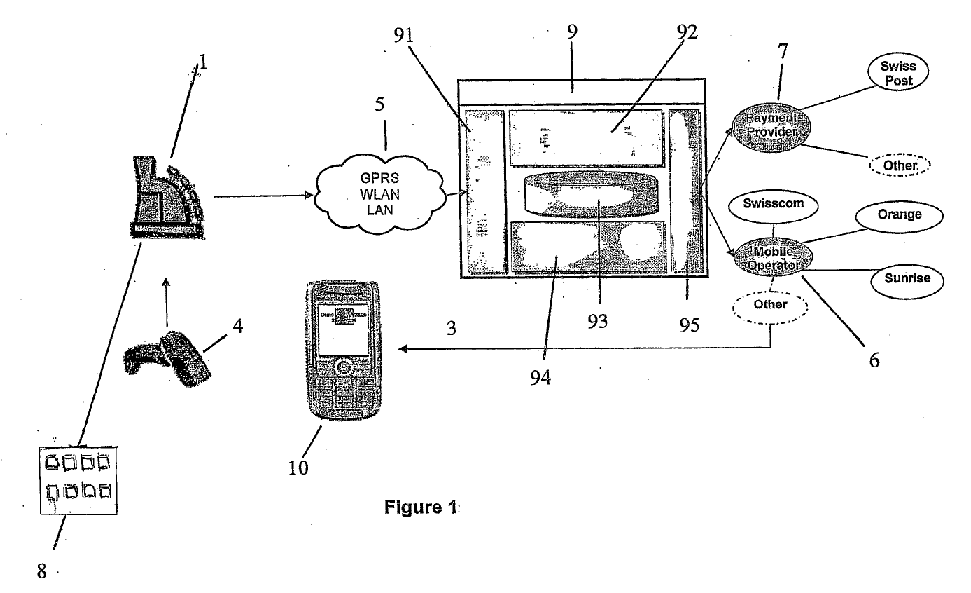

In prior mobile transactions solutions a multiple user (customer)/recipient (merchant) interaction was needed. In the solution of the present invention, the mobile device user (who is the customer) confirms a payment or other transactions in one single step (presenting the message with a symbol or format to the recipient or merchant scanner). In addition, prior art mobile transaction solutions re-used security codes. Each component within the process chain was vulnerable to unauthorized access. Further, since a hacker or other unauthorized user can “sniff” and record even message data, the reuse of these codes did not provide adequate security. The use of unique one time security code in the present invention code is unique and securely stored in the Innovative Mobile Transaction Platform (IMTP) database (see FIG. 1), which is a closed loop, unauthorized access is frustrated.

With specific reference to FIG. 1 a preferred embodiment of the present invention is shown including a recipient (merchant) cash desk designated by reference numeral 1 which is operatively connected to a scanner 4 and a PIN input device 8. The cash desk 1 is adapted to communicate via an appropriate link like for instance LAN, WLAN, GPRS etc. designated with reference numeral 5 with an Innovative Mobile Transaction Platform (IMTP) indicated generally with numeral 9. The IMTP 9 includes an application server 91, MMI (man machine interface) 92, a database 93, a messaging unit 94, and external interfaces 95 all to be described hereinafter. The IMTP 9 interfaces with a payment provider 7, such as SwissPost or the like to authorize and effect a transaction and a mobile operator 6, such as Swisscom, Orange, Sunrise, Vodafone or the like to provide the data of an authorized transaction via a wireless communication channel 3 to a mobile phone or smart phone 10 or a similar device like a PDA (not shown) of a customer which data can be scanned into the recipient (merchant) cash desk 1.

In FIG. 1 only one single scanner 4 is shown which is used both to scan transaction data (price of a product to be purchased, product code etc.), customer data (number of the mobile device or an assigned registration number) and visual symbols (barcode). Therefore, the recipient (merchant) cash desk 1 integrates point of sale (POS) functionality. However, the person skilled in the art will appreciate that separate scanners can be used one for merchandise data/transaction data, one for customer data and visual symbols, and in the latter case the POS functionality may be separate from cash desk register 1.

According to one aspect of the present invention the parties involved in
Recipient (Merchant, Shop)
Innovative Mobile Transaction Platform—IMTP operator
Payment provider (Bank, Financial Institute)
Mobile Network Operator
Customer

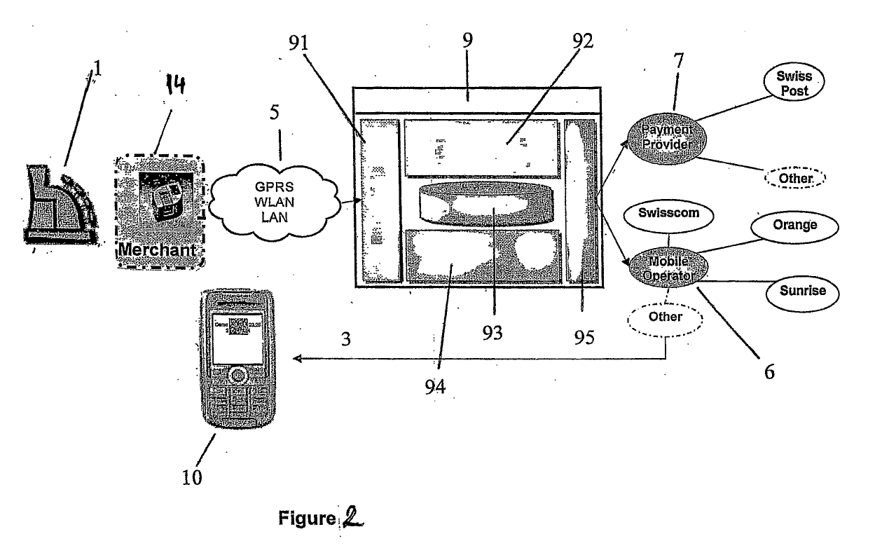

According to a preferred method of the invention which is described with respect to an embodiment integrating the POS functionality of FIG. 1 and to one embodiment with a dedicated barcode scanner as shown in FIG. 2, at a first step, a recipient (merchant) initiates a payment transaction by typing in or scanning the requested price of the merchandise to be purchased (transaction data) and the mobile device number or registration number (customer data) of a customer who wants to purchase the merchandise. The input device could be the recipient (merchant) cash desk register 1 including the scanner 4 (hereinafter only cash desk register for the sake of simplicity) or a dedicated barcode scanner 14 as shown in FIG. 2.

Furthermore, the safety of the method/system may be also increased if a PIN, which may be a service specific PIN assigned to the user/customer prior to the activation of the inventive payment system, is input by the customer via the input device 8 as shown for instance in FIG. 1. In a similar manner the PIN may be input via a keyboard provided on the dedicated barcode scanner 14 of FIG. 2.

It should be further noted that the PIN may also be altered by the customer, such that the customer ultimately may use the same PIN for turning on the mobile device (or any other PIN of his/her choice) and for confirming the transaction with the IMTP. It should be also noted that the original PIN and the registration number are preferably assigned to the customer upon the registration process with the present payment system. In this case, the customer may be provided by mail with form of a tag bearing a 2D barcode that can be adhered to the mobile device. Nevertheless, as an alternative, it is contemplated that the number of the mobile device and/or the PIN thereof are used instead of the specially assigned registration number and/or PIN.

Accordingly, information including the price of the merchandise to be purchased (transaction data), the registration number (customer data) and possibly the PIN, if the latter is required, are available at the cash desk register 1 of FIG. 1 or the dedicated barcode scanner 14 of FIG. 2.

In a second step this information is combined with a unique ID from the cash desk register 1 of FIG. 1 or the dedicated barcode reader 14 of FIG. 2, which ID may be embodied as the serial number of the cash desk register or of the dedicated barcode reader, and is transmitted over the wire or wireless network 5 (LAN, WLAN, GPRS etc.) for receipt by the Innovative Mobile Transaction Platform (IMTP) 9.

The application server 91 of the IMTP 9 provides for appropriate interfacing capabilities with the cash desk register 1 or the dedicated barcode scanner 14 and routs, in a third step, the information combined with the unique ID to database 93 where a check occurs whether the customer was previously registered with the IMTP 9.

In the case of the customer who has not previously registered with the IMTP 9, a registration process starts to collect necessary customer data via a man machine interface (MMI) 92.

If the customer is registered within the IMTP 9, the IMTP 9 converts or maps, in a fourth step, the received registration number into a card number which system with an electronic fund transfer at point of sale (EFT/POS) transaction. In this manner the IMTP 9 according to the present invention appears to the payment provider 7 as a conventional credit card or electronic cash card transaction requester, and advantageously no further modifications at the end of the payment provider 7 are necessary to complete a transaction. Alternatively, the conversion of the customer's registration number into a card number may occur at the end of the payment provider 7.

The IMTP 9 communicates, in a fifth step, the combined information including the registration number or the card number via the external interface 95 to an acquiring system and an issuer authorization system of the payment provider 7 where the authorization is handled in a conventional manner as in EFT/POS transaction when a card number is available. Otherwise, an additional conversion step would be required at the payment provider 7. The authorization request may include plausibility checks, including a plausibility check against a daily limit which is preferably only applicable for present IMTP type transaction. If the acquiring system does not send a response to the IMTP 9 within a preset time (i.e. a given time out), the IMTP 9 generates a reversal request that is confirmed by the acquiring system by a reversal acknowledgment.

In a subsequent sixth step, the authorization information of the transaction is sent by the issuer authorization system via external interface 95 to the IMTP 9 and the IMTP 9 saves the received authorization information in a database record of the database 93 with additional generated attributes like Transaction ID, security code etc. and then uses this authorization information along with the additional attributes to generate a message, namely the visual symbol embedded in an SMS, MMS, Email, or the like containing a machine readable visual symbol or format such as a 2D barcode. In addition further text information like merchant name, date, amount and the like may be associated with the visual symbol, such

It should be noted that according to a preferred aspect of the invention the security code stored in the data base 93 is a unique one time security code that never leaves the IMTP 9.

This visual symbol, possibly with associated text information, is then sent to a mobile device of the customer via the external interface 95 and a mobile network operator 6.

Upon receipt in the mobile device of the customer, the customer may provide the received visual symbol, possibly with associated text information, to the scanner 4 of the cash desk register 1, when the invention is implemented with an integrated POS functionality, or to the dedicated barcode scanner 14. The scanned and decoded visual symbol is sent back to the IMTP, and thus the transaction may be completed.

In the first embodiment shown in FIG. 1 the inputting of all data including transaction data (price of a product to be purchased, product code etc.), customer data (number of the mobile device or registration number) and visual symbols (barcode) is provided via a single scanner, although it will be appreciated that one or more similar electronic or optical means may be used.

In the second embodiment as shown schematically in FIG. 2, where the separate dedicated barcode scanner 14 is used for reading the visual symbols of the mobile device, a barcode scanner with GSM/GPRS communication capability may be used that is commercially available from the firm Gavitec AG, Jens-Otto-Krag-Str. 11, 52146 Würselen, Germany. All other relevant data necessary to perform a transaction like price of a product to be purchased, number of the mobile device or registration number, PIN etc. may be inputted by means of the embodiment provides for the advantage of rendering possible the upgrading of already existing equipment at the end of the merchant, like a conventional cash desk register.

It should also be noted that any other dedicated barcode scanner that is capable of reading visual symbols from a mobile phone display (e.g., a barcode scanner commercially available from Denso AG, a subsidiary of Toyota Tsusho Europe S. A., Denso ID Systems Department, Carl-Schurz-Str. 2, 41460 Neuss, Germany) or the like may be used.

In a seventh step the merchant, namely the scanner of the cash register or the dedicated barcode scanner, receives the visual symbol (possibly including the text information) from the customer's mobile device 10, and will then send the received and decoded visual symbol via wire or wireless network to the IMTP 9 as a confirmation/receipt.

The IMTP 9 will then validate, in an eighth step, the decoded visual symbol sent in the seventh step against the authorization information saved in a database record of the database 93 at the sixth step. If there is no match, an error message will be sent to the merchant device and no transaction will be performed.

If there is a positive validation, the transaction may proceed. At this point, at a ninth step, the payment provider 7 receives from the IMTP 9 the data needed for the financial transaction (debit/credit). Simultaneously the recipient (merchant) receives a confirmation message. If desired, the recipient can optionally print out receipt for the customer.

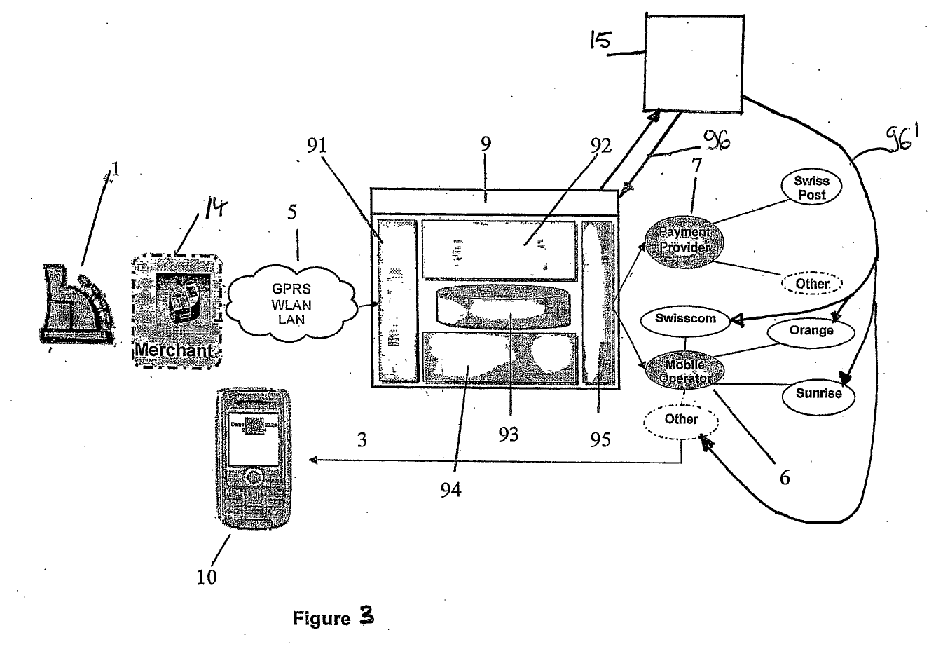

With reference to FIG. 3 an enhancement of the second embodiment of the invention including a coupon module 15 is shown. Nevertheless, the person embodiment of FIG. 1. The coupon module 15 is operatively connected to a mobile operator 6 and is adapted to selectively provide, inter alia, vouchers or loyalty points to selected customers which can be used upon a purchase via IMTP 9.

Advantageously, the enhanced second embodiment includes means (not shown) to recognize the mobile device of a customer when entering a specific store for which vouchers or loyalty points are available according to the profile of the customer. The recognition system may be based on blue tooth or any known triangulation systems which are familiar to those skilled in the art of mobile phone/GSM systems. Therefore, the description thereof will be omitted.

Upon effecting a transaction in the manner described in connection with the embodiments of FIGS. 1 and 2, the coupon module 15 provides to the IMTP, upon request of the IMTP, information according to the profile of the recognized customer, as indicated by arrow 96 in FIG. 3, and such information including vouchers or coupons is then taken into account while effecting the transaction.

Alternatively, the voucher/couponing information can be sent in a similar manner as indicated by the arrow 96′ directly from the coupon module 15 via the mobile operator 6 in form of a machine readable visual symbol or format such as a 2D barcode and possibly text information in clear writing. In the latter alternative, the transaction is performed by scanning two machine readable visual symbols sent via SMS or the like, namely one representative of the transaction and one representative of the voucher/coupon information. In fact, it will be appreciated by the skilled reader that the voucher/coupon information may be sent to the customer immediately upon the recognition step, prior to effecting a transaction, such that the customer is informed prior to the purchasing of vouchers or coupons available to him. tion is used to carry out mobile payments such as Ad hoc or instant payment, mobile bill presentment and payment (EBPP), vouchers (discounts, gift coupons and bonus), and the like, it will be understood that the solution of the present invention can be applied to carry out the following services:

Mobile Ticketing
Indoor Arena (events, concerts, stadium, sport, etc.)
Outdoor Arena (events, concerts, stadium, sport, etc.)
Public transportation (Rail, Coaches, Metro, etc.)

Mobile Access
Physically Access (temporary)
Doors, Barriers, and Gates (e.g. visitor parking)
Vehicles (e.g. rental cars)

Electronic Access

Used for one-time access to sensitive information. In such a case the user should get access to information which is usually not available to him. He would then get a message with a symbol or format which could be read by a scanner attached to the terminal. The access point could be located anywhere (e.g. Internet Coffee, Event Lobby Halls, etc.).

The described solution enables the customer to confirm the payment, requested by the recipient/merchant in one step without any additional typing, namely by merely presenting the visual symbol. This fact delivers an outstanding and unique usability for the customer. The solution offers a one step confirmation without any additional typing or voice interaction. The process does not need a rollback procedure from the financial transaction because the trigger for the financial transaction will only be generated after a positive validation occurred. As recipient a financial transaction will not proceed. In addition, a hacker or a “man in the middle” cannot manipulate the process chain or even the message itself at any point. This is because the unique security code generated by the solution remains within the Innovative Mobile Transaction Platform (IMTP) solution architecture. Since the process chain is a closed loop, the correct security code will always be requested before a financial transaction will be executed.

Clearly, several modifications will be apparent to and can be readily made by the person skilled in the art without departing from the scope of the present invention.

For instance, the transaction performed by the customer is not limited to one per visual symbol but it may include sub-transactions for which a single visual symbol is sent to the customer. By way of example one may envisage a situation where a customer effects, upon purchasing goods in a store (first sub-transaction), also a second sub-transaction which is the payment of his parking ticket. In such case the same visual symbol is used in both sub-transactions. In a similar manner a person may, upon purchasing a ticket for a sporting or cultural event, also effect several sub-transactions like advance payment of beverages/food, of a parking ticket, a program etc. yet again by using the same visual symbol. Clearly, the IMTP and/or the payment provider 7 must be adapted, in a manner familiar to the person skilled in the art, to handle the multiple use of the same visual symbol.

Therefore, the scope of the claims shall not be limited by the illustrations or the preferred embodiments given in the description in the form of examples, but rather the claims shall encompass all of the features of patentable novelty that reside in the present invention, including all the features that would be treated as equivalents by the person skilled in the art. signs, those reference signs have been included just for the sole purpose of increasing intelligibility of the claims and accordingly, such reference signs do not have any limiting effect on the scope of each element identified by way of example by such reference signs.

1. A system for providing a mobile transaction, such as a payment, the system including:
a first means (1, 14) at a point of sale for entering transaction data and customer data and having a unique ID associated therewith; and
a mobile transaction platform (9) connected via a first link (5) to the first means (1, 14),
the mobile transaction platform (9) being adapted to receive the transaction data, the customer data and the unique ID, and to provide the transaction data, the customer data and the unique ID to a payment provider (7) for authorizing an electronic fund transfer at the point of sale,
the mobile transaction platform (9) being further adapted to provide the authorization information of the payment provider (7) via a second link (3), which is distinct from the first link (5), to a mobile device (10) of the customer, wherein the authorization information is in form of a machine readable visual symbol,
the first means (1, 14) being adapted to read and decode the visual symbol from the mobile device (10) and to send the decoded visual symbol via the first link (5) to the mobile transaction platform (9) for finalizing the transaction.

2. The system of claim 1 including second means (8, 14) adapted to enter a PIN associated with the customer data and provide the PIN to the first means (1, 14), the mobile transaction platform (9) being adapted to further receive the PIN, such that the transaction data, the card number, the unique ID and the PIN can be used by the payment provider (7) for authorizing an electronic fund transfer at the point of sale.

3. The system of claims 1 or 2 wherein the customer data is in form of a registration number assigned to the customer upon the registration process with the payment provider (7), the registration number being provided on a tag as a 2D

4. The system of one or more of claims 1-3 wherein the visual symbol is in the form a 2D barcode.

5. The system according to one or more of claims 1-4 wherein the visual symbol is embedded in an SMS, MMS or Email.

6. The system according to one or more of claims 1-5 wherein the mobile transaction platform (9) is further adapted to generate text information like merchant name, date, amount and the like, and send the text information in association with the visual symbol to the mobile device (10), such that transaction details are legible in clear text for the customer.

7. The system according to one or more of claims 1-6 wherein the first means (1) includes a cash register (1) and a scanner (4), the cash register (1) integrating point of sale functionality, the scanner (4) being adapted to read the transaction data, the customer data and the visual symbol, and
wherein the second means (8) includes a PIN input device (8) operatively connected to the cash register.

8. The system according to one or more of claims 1-6 wherein the first means (14) includes a dedicated barcode reader (14) having a keyboard for entering the transaction data, the dedicated barcode reader (14) being devised such that to scan the visual symbol and the customer data; and
wherein the second means is also implemented in the keyboard of the dedicated barcode reader (14).

9. The system according to one or more of claims 1-6 wherein the first means (14) includes a dedicated barcode reader (14) having a keyboard for (14) being devised such that to scan the visual symbol, and
wherein the second means is also implemented in the keyboard of the dedicated barcode reader (14).

10. The system according to one or more of claims 1-9 wherein the first link (5) is a LAN, WLAN or GPRS link, and
wherein the second link (3) is a wireless communication channel.

11. The system according to one or more of claims 1-10 wherein the mobile device (10) is a mobile phone, a smart phone or a PDA.

12. The system according to one or more of claims 1-11 wherein the mobile transaction platform (9) is further adapted to convert the customer data into a card number and to send the card number to the payment provider (7), the payment provider (7) authorizing an electronic fund transfer at the point of sale based on the card number.

13. The system according to one or more of claims 1-11 wherein the payment provider (7) is adapted to convert the customer data into a card number and for obtaining authorization for an electronic fund transfer at the point of sale based on the card number.

14. The system according to one or more of claims 1-13 wherein the mobile payment platform (9) includes an application server (91), a database (93) and an external interface (95),
the application server (91) providing for interfacing capabilities with the first means (1, 14) and routing the transaction data, the customer data, and the unique ID to the database (93), where a check occurs whether the customer was previously registered with the mobile payment platform (9), and payment provider (7) where the authorization is handled based on the customer data or the card number.

15. The system according to one or more of claims 1-14 wherein the payment provider (7) generates and sends a unique one time security code to the mobile payment platform (9), such that the security code never leaves the mobile payment platform (9).

16. A method for providing a mobile transaction, such as a payment, the method including the steps of:
providing transaction data and customer data at first means (1, 14) at a point of sale as well as a unique ID associated with the first means (1, 14);
transmitting the transaction data, the customer data, and the unique ID from the first means (1, 14) via a first link (5) to a mobile transaction platform (9), the mobile transaction platform (9) being adapted to receive the transaction data, the customer data and the unique ID, and to provide the transaction data, the customer data and the unique ID to a payment provider (7) for authorizing an electronic fund transfer at the point of sale;
providing the authorization information of the payment provider (7) from the mobile transaction platform (9) via a second link (3), which is distinct from the first link (5), to a mobile device (10) of the customer, wherein the authorization information is in form of a machine readable visual symbol;
reading and decoding at the first means (1, 14) the visual symbol from the mobile device (10); and
sending the decoded visual symbol via the first link (5) to the mobile transaction platform (9) for finalizing the transaction.

17. The method of claim 16, further including the step of entering a PIN associated with the customer data and providing the PIN to the first means (1, 14) number, the unique ID and the PIN can be used by the payment provider (7) for authorizing an electronic fund transfer at the point of sale.

18. The method of claims 16 or 17 wherein the customer data is in form of a registration number assigned to the customer upon the registration process with the payment provider (7), the registration number being provided on a tag as a 2D barcode that can be adhered to the mobile device (10).

19. The method of one or more of claims 16-18 wherein the visual symbol is in the form a 2D barcode.

20. The method according to one or more of claims 16-19 wherein the visual symbol is embedded in an SMS, MMS or Email.

21. The method according to one or more of claims 16-20 wherein the mobile transaction platform (9) or the payment provider (7) is further adapted to generate text information like merchant name, date, amount and the like, and further including the step of sending the text information in association with the visual symbol to the mobile device (10), such that transaction details are legible in clear text for the customer.

22. The method according to one or more of claims 16-21 wherein the first link (5) is a LAN, WLAN or GPRS link, and
wherein the second link (3) is a wireless communication channel.

23. The method according to one or more of claims 16-22 wherein the mobile device (10) is a mobile phone, a smart phone or a PDA.

24. The method according to one or more of claims 16-23 wherein the a card number, and further including the step of sending the card number to the payment provider (7), the payment provider (7) authorizing an electronic fund transfer at the point of sale based on the card number.

25. The method according to one or more of claims 16-23 wherein the payment provider (7) is adapted to convert the customer data into a card number and for obtaining authorization for an electronic fund transfer at the point of sale based on the card number.

26. The method according to one or more of claims 16-25 wherein the payment provider (7) generates and sends a unique one time security code to the mobile payment platform (9), such that the security code never leaves the mobile payment platform (9).
